(19) United States
(12) Patent Application Publication
(10) Pub. No.: US 2004/0235329 A1
(43) Pub. Date: Nov. 25, 2004

(54) Socket connector

(76) Inventors: Hideyuki Hirata, Kanagawa (JP); Takaaki Hirayama, Kanagawa-ken (JP)

Correspondence Address: Robert J Zeitler, Molex Incorporated, 2222 Wellington Court, Lisle, IL, 60532, US

(21) Appl. No.: 10/483,098

(22) PCT Filed: Jul. 2, 2002
(86) PCT No.: PCT/US02/20898

(30) Foreign Application Priority Data
Jul. 6, 2001 (JP) 2001206379

(51) Int. Cl. H01R 13/625

(52) U.S. Cl. 439/342

(57) ABSTRACT

The present invention relates to a socket connector, and more particularly, to provide a socket connector that may prevent the upward movement on both sides of cover portions with respect to an axis of one shaft of an L-shaped lever when the lever is moved from a first position to a second position, and vice versa The socket connector includes a socket body, an L-shaped lever supported swingably about one shaft thereof, a semiconductor package tray plate mounted slidably on the socket body, and a cover formed integrally with the semiconductor package tray plate for covering one shaft of the L-shaped lever, wherein in the case where the L-shaped lever is swung, an eccentric portion formed integrally with the one shaft biases the cover whereby the semiconductor package tray plate is slidingly moved. The socket connector further includes means for limiting the upward movement of cover portions located on both sides of an axis of the one shaft of the L-shaped lever.

### FIELD OF THE INVENTION

The present invention relates to a socket connector, and more particularly, to provide a socket connector that may prevent the upward movement on both sides of cover portions with respect to an axis of one shaft of an L-shaped lever when the lever is moved from a first position to a second position, and vice versa.

### BACKGROUND OF THE INVENTION

A conventional socket connector, in which a semiconductor package tray plate is slidingly moved by an eccentric portion formed integrally on one shaft of an L-shaped lever when the L-shaped lever is swung about one shaft of the L-shaped lever, is known by the publication Japanese Patent Examined Publication No. Hei 7-34381.

A socket 300 described in that publication is provided, as shown in FIGS. 9, 10 and 11, with an L-shaped lever 301 swingably supported about one shaft 301a thereof, a semiconductor package tray plate 303 slidably mounted on a socket body 302 and a cover 303a formed integrally with the semiconductor package tray plate 303 for covering one shaft 301a of the L-shaped lever 301. In the case where the L-shaped lever 301 is swung, an eccentric portion 301b formed integrally with the one shaft 301a biases the inside surface of the cover 303a so that the socket 300 slides and moves the semiconductor package tray plate 303. The socket 300 is provided with a depression bar 304 disposed on a top surface of one edge of the cover 303a and supported at both ends by the socket body 302 (a top surface of the cover portion located on one side of the axis of one shaft 301a).

In the above-described socket 300, in the case where the L-shaped lever 301 is swung from the position of the L-shaped lever 301 shown in FIG. 10 to the position of the lever 301 shown in FIG. 11 (or vice versa), the eccentric portion 301b of the L-shaped lever 301 biases the inside surface of the cover 303a. For this reason, one end edge top surface 303b of the cover 303a is liable to warp, or move, upwardly. However, since the one end top surface 303b of the cover 303a is brought into contact with a pressure bar 304, the upward movement is prevented.

However, in the thus constructed socket 300, there is a problem in that not only one side 303b of the cover 303 but also other side (the cover portion located on the opposite side with respect to the axis of one shaft 301a) are liable to warp upwardly.

Also, since the pressure bar 304 is composed of a round rod having a substantially circular shape in cross section, when one side 303b of the cover 303 is liable to warp upwardly, the surface of the pressure bar 304 and the one end edge top surface 303b of the cover 303a are brought into linear contact with each other. For this reason, the effect for limiting the movement is relatively weak. Accordingly, there is a problem in that it is impossible to effectively prevent the upward movement of one side 303b of the cover 303.

### SUMMARY OF THE INVENTION

A first object of the present invention is to provide a socket connector that may prevent the upward movement of cover portions located on both sides with respect to an axis of one shaft of an L-shaped lever when the lever is swung.

A second object of the present invention is to provide a socket connector that may more effectively prevent the upward movement of a portion located on one side with respect to one shaft of an L-shaped lever.

In order to attain the above-described objects, according to the present invention, there is provided a socket connector comprising: a socket body; an L-shaped lever supported swingably about one shaft thereof, a semiconductor package tray plate mounted slidably on the socket body; and a cover formed integrally with the semiconductor package tray plate for covering one shaft of the L-shaped lever, wherein in the case where the L-shaped lever is swung, an eccentric portion formed integrally with the one shaft biases the cover whereby the semiconductor package tray plate is slidingly moved, characterized by comprising a limit means for limiting the upward movement of cover portions located on both sides of an axis of the one shaft of the L-shaped lever.

According to the present invention, a limit means for limiting the upward movement of cover portions located on both sides of an axis of the one shaft of the L-shaped lever is provided. Accordingly, it is possible to prevent the upward movement of cover portions located on both sides with respect to an axis of one shaft of an L-shaped lever when the lever is swung.

The limit means is provided with an upward movement limiting portion provided integrally with the socket body and an engagement portion engaging with the upward movement limiting portion, and the engagement portion is provided on each of the cover portion located on both sides with respect to the axis of the one shaft of the L-shaped lever.

Thus, since the engagement portions of the cover portion on both sides are engaged with the upward movement limiting portion of the socket body, it is possible to more effectively prevent the upward movement, i.e., upward movement of the cover portions on both sides

The upward movement limiting portion has an upward movement limiting surface, and the engagement portion has an engagement surface in surface contact with the upward movement limiting surface. Thus, since the engagement surfaces of the cover portions on both sides are brought into surface contact with the upward movement limiting surface, it is possible to more effectively prevent the upward movement.

It is preferable that the upward movement limiting portion is disposed at a predetermined interval on a surface of the socket body and includes a laterally extending portion extending in a direction substantially perpendicular to the slide direction of the semiconductor package tray plate, and the upward movement limiting surface is provided on a lower surface of the laterally extending portion.

Thus, the engagement portion is inserted in between the socket body surface (top surface) and the laterally extending portion to thereby make it easy to the engagement.

It is preferable that the engagement portion includes a projection portion projecting from the cover portion located one side of the axis of the one shaft of the L-shaped lever, and the engagement surface is provided on the top surface of the projection portion. Thus, the engagement portion is inserted in between the socket body surface (top surface) and the laterally extending portion to thereby make it easy to engage.

Also, it is preferable that the upward movement limiting portion includes a longitudinally extending portion extending upwardly from the socket body surface and an engagement claw provided at its end, and the upward movement limiting surface is provided on a lower surface of the engagement claw. Thus it is possible to readily engage the upward movement limiting surface with the engagement surface.

Also, it is preferable that the engagement portion includes a through hole into which the longitudinally extending portion is inserted and which is formed in the cover portion located on the other side with respect to the axis of one shaft of the L-shaped lever, and the engagement surface is provided on a surface of the cover portion in the vicinity of the through hole. Thus it is possible to readily engage the upward movement limiting surface with the engagement surface.

Other objects, features and advantages of the invention will be apparent from the following detailed description taken in connection with the accompanying drawings.

### BRIEF DESCRIPTION OF THE DRAWINGS

The invention, together with its objects and the advantages thereof, may be best understood by reference to the following description taken in conjunction with the accompanying drawings, in which like reference numerals identify like elements in the figures and in which:

FIG. 1 is a perspective view of a socket according to the present invention.

FIG. 2 is a perspective view illustrating a relationship between a socket body constituting the socket and a semiconductor package tray plate related to the present invention.

FIG. 3 is a plan view showing the arrangement in which an L-shaped lever is disposed on the socket body constituting the socket related to the present invention.

FIG. 4 is a perspective view as viewed from the back surface of the semiconductor package tray plate constituting the socket related to the present invention.

FIG. 5 is a cross-sectional view of the socket taken along the line A-A of FIG. 1.

FIG. 6 is a cross-sectional view of the socket taken along the line A-A of FIG. 1.

FIG. 7 is a cross-sectional view of the socket taken along the line B-B of FIG. 1.

FIG. 8 is a cross-sectional view of the socket taken along the line B-B of FIG. 1.

FIG. 9 is a view illustrating a problem of the conventional example of the socket connector according to the present invention.

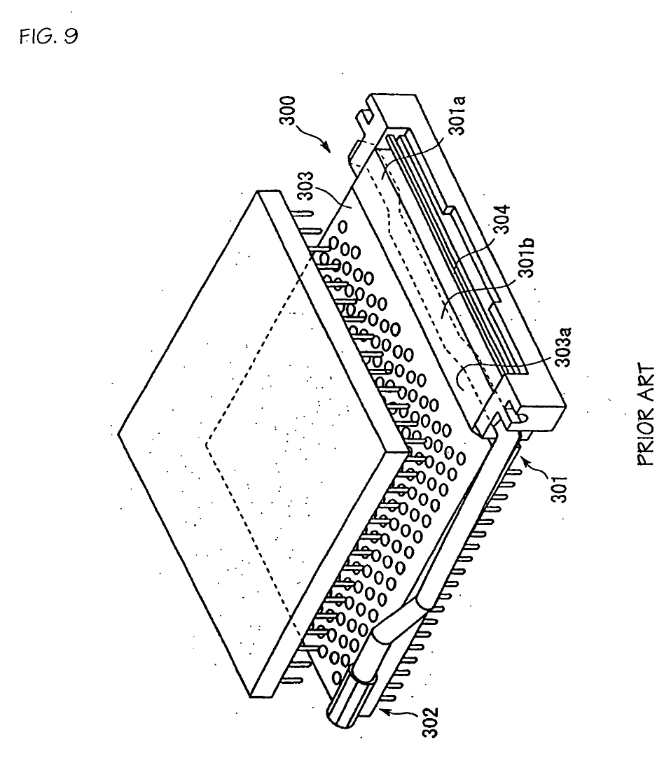

FIG. 10 is a view illustrating a problem of the conventional example of the socket connector according to the present invention.

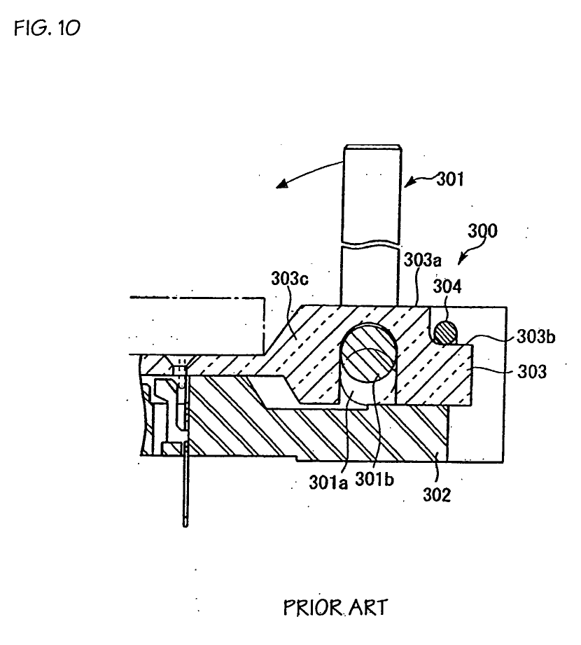

FIG. 11 is a view illustrating a problem of the conventional example of the socket connector according to the present invention.

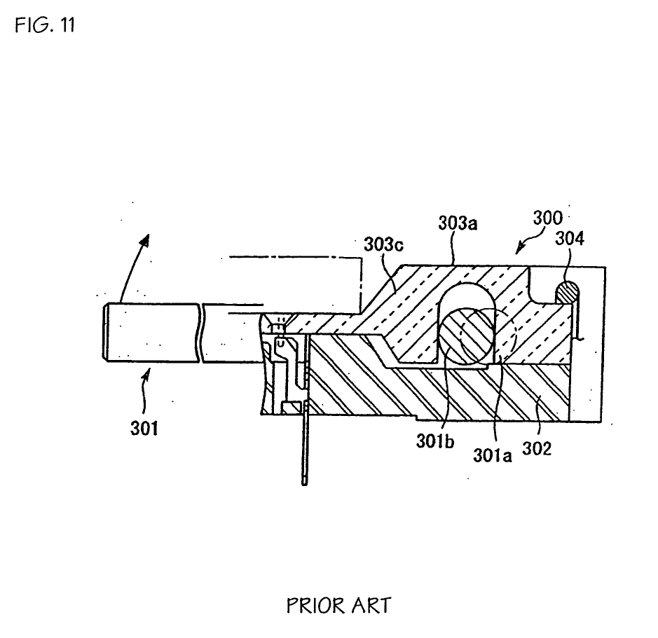

### DETAILED DESCRIPTION OF THE ILLUSTRATED EMBODIMENT

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

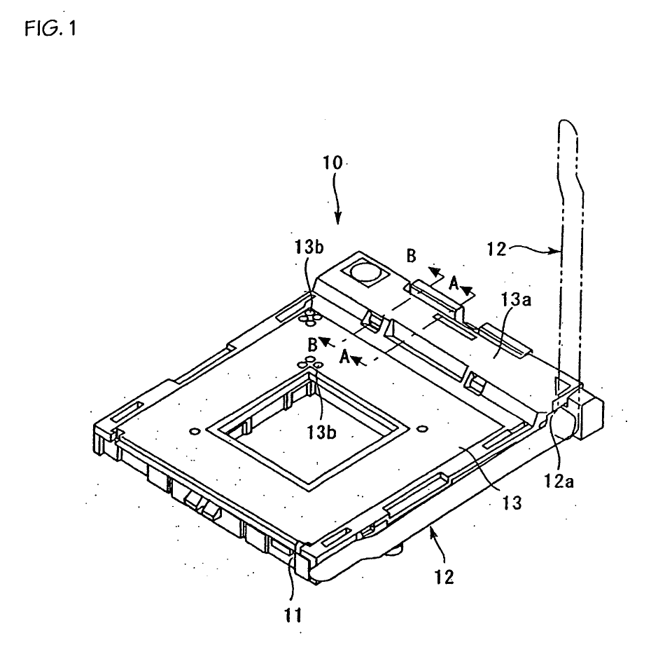

A socket connector (hereinafter simply referred to as a socket) in accordance with the present invention will now be described with reference to the drawings. As shown in FIGS. 1, 2 and 3, the socket 10 is formed into a thin box shape in outer appearance.

In the socket 10, a semiconductor package (not shown) is placed on the semiconductor tray plate 13 with a zero insertion force or a low insertion force and the lever 12 is swung from the upright (first, or open) position to the horizontal (second, or closed) position to thereby slide and move the semiconductor package tray plate 13 and each pin terminal of the semiconductor package is brought into the associated contact provided in the socket body 11.

The socket 10 is provided with the socket body 11, the L-shaped lever 12 supported swingably about one shaft 12a, the semiconductor package tray plate 13 mounted slidably on the socket body 11, and a cover 13a for covering one shaft 12a of the L-shaped lever 12 and formed integrally with the semiconductor package tray plate 13.

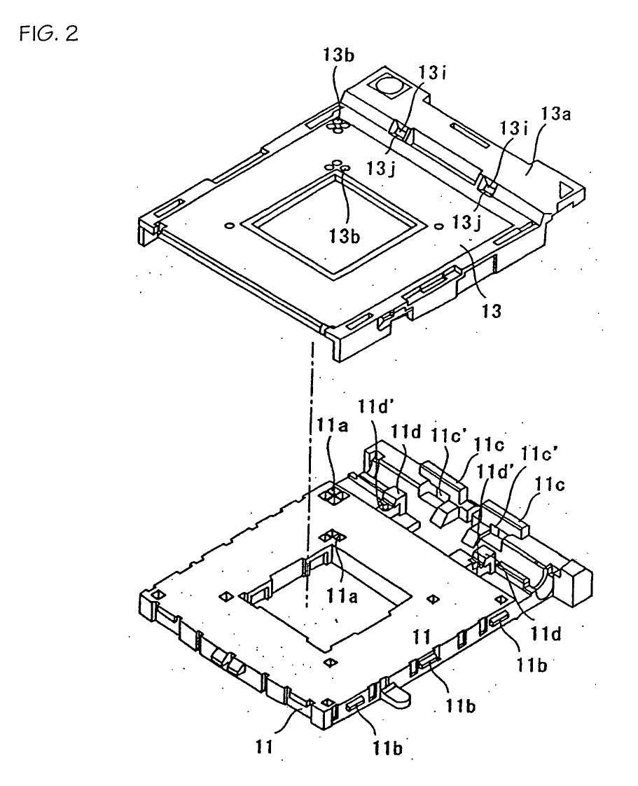

A plurality of contact receiving holes 11a, arranged corresponding to the arrangement of the pin terminals of the semiconductor package, are formed in the socket body 11 as shown in FIG. 2. The contacts (not shown) that come into contact with the pin terminals of the semiconductor package are received in the respective contact receiving holes 11a.

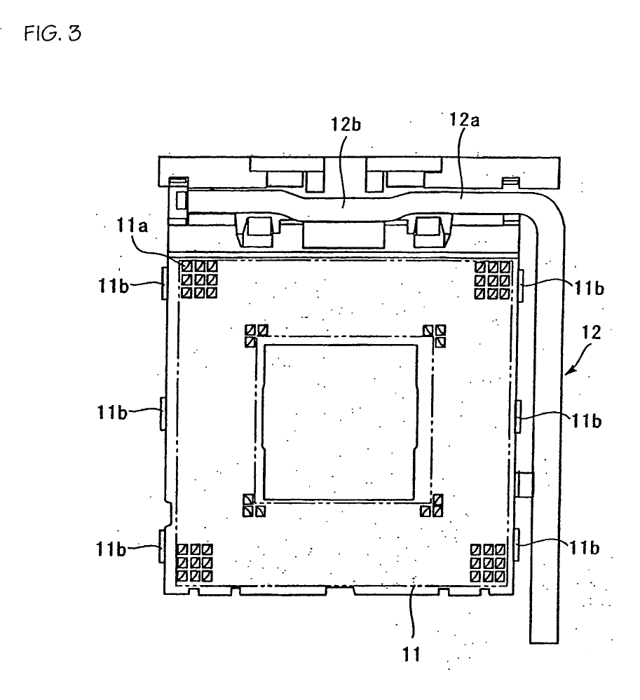

As shown in FIG. 3, one shaft 12a of the L-shaped lever 12 is disposed at one edge of the socket body 11. The one shaft 12a of the L-shaped lever 12 is covered by the cover 13a formed integrally with the semiconductor package tray plate 13.

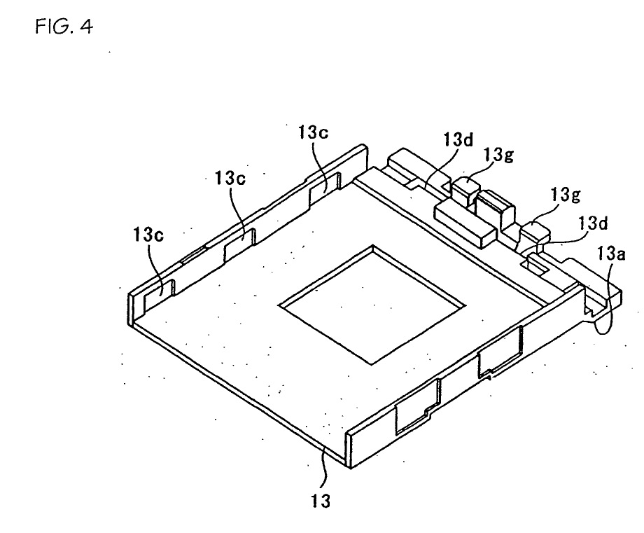

As shown in FIGS. 1 and 2, a plurality of through holes arranged corresponding to the arrangement of the pin terminals of the semiconductor package are formed between the top and bottom surfaces of the semiconductor package tray plate 13. The both edges, in the width direction, of the semiconductor package tray plate 13 extend downwardly, respectively. A plurality of guide grooves 13c, are formed in its inside surface (see FIG. 4). A plurality of projection portions 11b, provided in both surfaces, in the width direction, of the socket body 11 are inserted into the respective guide grooves 13c and the slide direction of the semiconductor package tray plate 13 is guided to the socket body 11.

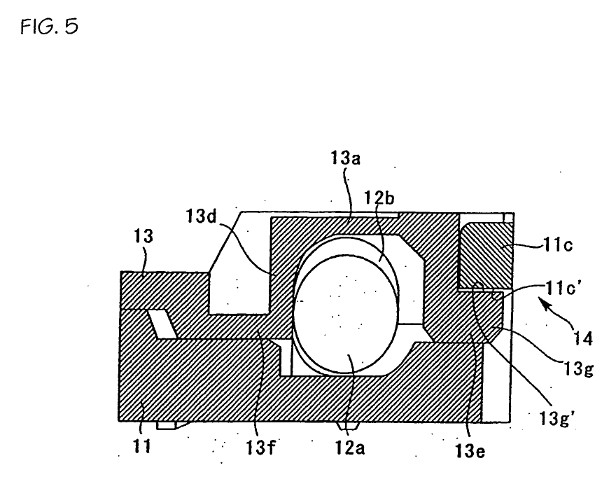

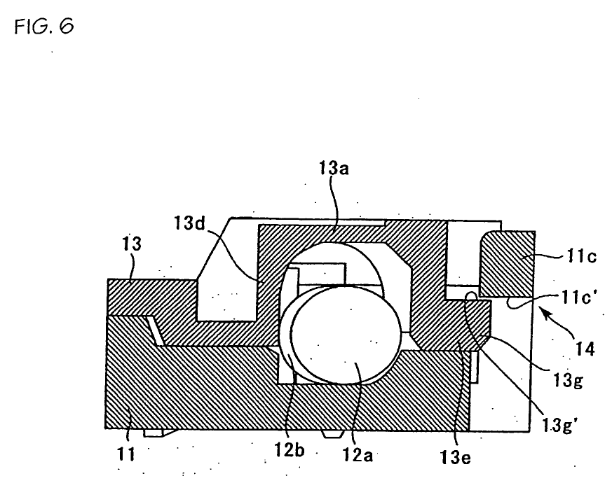

As shown in FIGS. 4, 5 and 6, lever contact portions 13d with which the eccentric portion 12b formed integrally with one shaft 12a of the lever 12 is brought into contact are formed in the lower surface of the cover 13a. In the case where the L-shaped lever 12 is swung from the upright position (the position of the lever 12 indicated by two-dot-and-dash lines in FIG. 1) to the horizontal position (the position of the lever 12 indicated by solid lines in FIG. 1) (or vice versa), the eccentric portion 12b of the lever 12 biases the lever contact portions 13d of the lower surface of the cover 13a to thereby slide and move the semiconductor package tray plate 13. FIG. 5 shows the position of the cover 13a when the lever 12 is in the upright position. FIG. 6 shows the position of the cover 13a when the lever 12 is in the horizontal position.

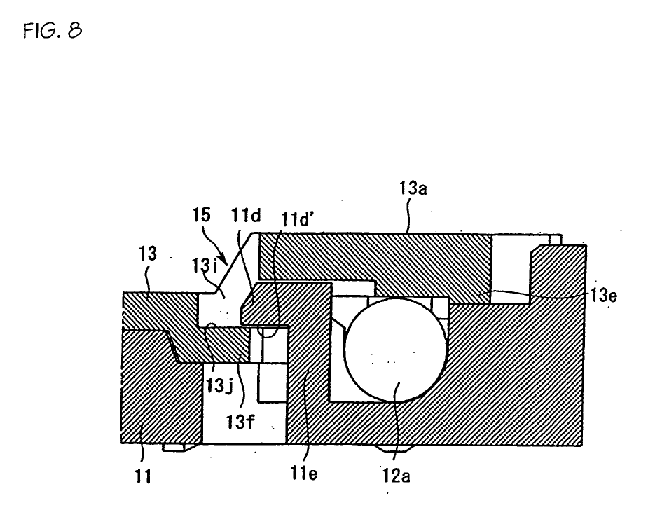

As shown in FIGS. 5, 6, 7 and 8, the socket 10 is provided with limiting means 14 and 15 for limiting the upward movement of the cover portions 13e and 13f located on both side with respect to the axis of one shaft 12b of the L-shaped lever 12.

As shown in FIGS. 2, 5 and 6, the limiting means 14 is provided with a laterally extending portion 11c used as an the upward movement limiting portion provided integrally with the socket body 11 and a projection piece 13g used as an engagement portion for engaging with the laterally extending portion 11c

The laterally extending portions 11c are arranged at a predetermined interval on the surface of the socket body 11 and extend in the substantially perpendicular direction to the sliding direction of the semiconductor package tray plate 13. Upward movement limiting surface 11c′ are formed on the lower surface of the laterally extending portions 11c.

Projection pieces 13g project outwardly from the cover portion 13e located on one side with respect to the axis of one shaft 12a of the L-shaped lever 12. Engagement surfaces 13g′ that come into surface contact with the upward movement limiting surfaces 11c′ of the laterally extending portion 11c are provided on the surface of the projection pieces 13g.

The projection pieces 13g are inserted into a gap between the socket body 11 surface and the upward movement limiting surface 11c′ of the laterally extending portions 11c so that the engagement surface 13g′ of the projection pieces 13g is engaged with the upward movement limiting surface 11c′ of the laterally extending portions 11c (see FIG. 5).

Accordingly, even if the cover portion 13e located on one side with respect to the axis of one shaft 12a of the L-shaped lever 12 is liable to warp upwardly in accordance with the swing of the L-shaped lever 12, because the projection piece 13g and the laterally extending portion 11c are engaged with each other, it is possible to prevent the cover portion 13e from warping back upwardly.

Also, it is possible to more effectively prevent the upward movement because the engagement surface 13g′ that is the top surface of the projection piece 13g and the upward movement limiting surface 11c′ that is the lower surface of the laterally extending portion 11c are brought into surface contact with each other.

As shown in FIGS. 4, 7 and 8, the limiting means 15 is provided with a vertically extending portion 11e and an engagement claw 11d used as the upward movement limiting portion provided integrally with the socket body 11 and a through hole 13i used as the engagement portion engaging with the upward movement limiting portion.

The vertically extending portion 11e extends upwardly from the surface of the socket body 11 and is provided at its tip end with the engagement claw 11d. The upward movement limiting surface 11d′ is provided on the lower surface of the engagement claw 11d.

The through hole 13i is formed in the cover portion 13f located on the other side with respect to the axis of one shaft 12a of the L-shaped lever 12. The engagement surface 13j that comes into surface contact with the upward movement limiting surface 11d′ of the engagement claw 11d is provided on the surface of the cover portion 13f in the vicinity of the through hole 13i.

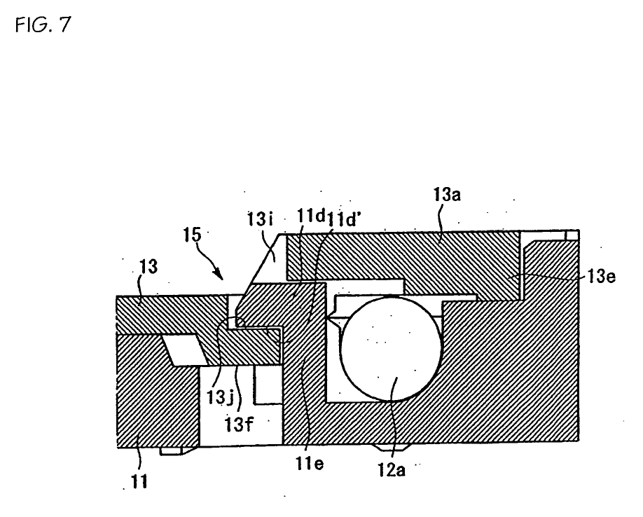

The extending portion 11e is inserted into the through hole 13i. The engagement claw 11d provided at the tip end of the extending portion 11e projects from the through hole 13i. The upward movement limiting surface 11d′ of the engagement claw 11d is engaged with the engagement surface 13j of the surface of the cover portion 13f in the vicinity of the through hole 13i (see FIG. 7).

Accordingly, it is possible to prevent the upward movement of the cover portion 13f even if the cover portion 13f located on the opposite side with respect to the axis of one shaft 12a of the L-shaped lever 12 is liable to warp upwardly (peel upwardly) in accordance with the swing of the L-shaped lever because the surface of the cover portion 13f in the vicinity of the through hole 13i and the engagement claw 11d are engaged with each other.

Also, since the engagement surface 13j that is the surface of the cover portion 13f in the vicinity of the through hole 13i and the upward movement limiting surface 11d′ that is the lower surface of the engagement claw 11d are brought into surface contact, it is possible to more effectively prevent the upward movement.

While a preferred embodiment of the present invention is shown and described, it is envisioned that those skilled in the art may devise various modifications of the present invention without departing from the spirit and scope of the appended claims. The present examples and embodiments, therefore, are to be considered in all respects as illustrative and not restrictive, and the invention is not to be limited to the details given herein.

1. A socket connector (10) comprising: a socket body (11); a lever (12) supported swingably about one shaft (12a) thereof, a semiconductor package tray plate (13) mounted slidably on said socket body; and a cover (13a) formed integrally with said semiconductor package tray plate for covering one shaft of said lever, wherein in the case where said lever is swung, an eccentric portion (12b) formed integrally with said one shaft biases said cover whereby said semiconductor package tray plate is slidingly moved,
characterized by comprising a means for limiting the upward movement of cover portions (14, 15), one of said means for limiting upward movement of cover portions being located on one side with respect to an axis of said one shaft of said lever and generally adjacent said one shaft and another of said means for limiting upward movement of cover portions being located on the ocher side with respect to an axis of said ore shaft of said lever and generally adjacent said one shaft.

2. The socket connector according to claim 1, wherein said means for limiting the upward movement of cover portions is provided with an upward movement limiting portion (11c, 11d) provided integrally with said socket body and an engagement portion (13g, 13j) engaging with said upward movement limiting portion, and
said engagement portion is provided on each of said cover portion located on both sides with respect to the axis of said one shaft of said lever.

3. The socket connector according to claim 2, wherein said upward movement limiting portion has an upward movement limiting surface (11c′, 11d′), and said engagement portion has an engagement surface in surface contact with said upward movement limiting surface.

4. The socket connector according to claim 3, wherein said upward movement limiting portion is disposed at a predetermined interval on a surface of said socket body and includes a laterally extending portion (11c) extending in a direction substantially perpendicular to the slide direction of said semiconductor package tray plate, and
said upward movement limiting surface is provided on a lower surface of said laterally extending portion.

5. The socket connector according to claim 3, wherein said engagement portion includes a projection portion (13g) projecting from the cover portion located on one side of the axis of said one shaft of said lever, and
said engagement surface is provided on the top surface of said projection portion

6. The socket connector according to claim 3, wherein said upward movement limiting portion includes a longitudinally extending portion (11e) extending upwardly from said socket body surface and an engagement claw (11d) provided at its end, and
said upward movement limiting surface is provided on a lower surface of said engagement claw.

7. The socket connector according to claim 3, wherein said engagement portion includes a through hole (13i) into which said longitudinally extending portion is inserted and which is formed in the cover portion located on the other side with respect to the axis of one shaft of said lever, and
said engagement surface is provided on a surface of the cover portion in the vicinity of said through hole.

8. The socket connector according to claim 1, wherein said lever is generally L-shaped.
